(19) United States
(12) Patent Application Publication
(10) Pub. No.: US 2009/0307909 A1
(43) Pub. Date: Dec. 17, 2009

(54) INNER BLADE FOR ELECTRIC SHAVER

(75) Inventors: Masaaki Sato, Hikone-shi (JP); Shunsuke Komori, Hikone-shi (JP); Jyuzaemon Iwasaki, Nagahama-shi (JP); Takeshi Shiba, Hikone-shi (JP)

Correspondence Address: GREENBLUM & BERNSTEIN, P.L.C., 1950 ROLAND CLARKE PLACE, RESTON, VA, 20191, US

(73) Assignee: PANASONIC ELECTRIC WORKS CO., LTD., Osaka (JP)

(21) Appl. No.: 12/374,484

(22) PCT Filed: Jul. 9, 2007
(86) PCT No.: PCT/JP2007/063648

§ 371 Date: Jan. 21, 2009

(30) Foreign Application Priority Data
Jul. 21, 2006 (JP) 2006-199953

(51) Int. Cl. B26B 19/28; B26B 21/40

(52) U.S. Cl. 30/42; 30/50

(57) ABSTRACT

In an inner blade (5) for electric shaver comprising plural blade elements (30) which are supported on a base (20), and reciprocally driven parallel to an outer foil blade (10) having beard/moustache/whisker introduction apertures (11) so as to cut beards, moustaches or whiskers by the inner blade and the outer foil blade, wherein the plural blade elements (30) are arranged in parallel each other; a pair of cutting edges (32) is provided symmetrically on both sides of a top portion of each blade element (30); each cutting edge (32) is established with a top face (31) of the blade element (30) and a cutting face (33) slanted for the top face (31); a cusp of the cutting edge (32) is rounded to have a radius of curvature R (μm); and as an angle of the cutting face for the top face is designated by a symbol α (degree), the radius of curvature R of the cusp of the cutting edge is selected to satisfy a relation that R≦−0.02·α+1.1 (μm).

### TECHNICAL FIELD

The present invention relates to an inner blade for electric shaver, and for details, relates to an inner blade which is used for reciprocation driving type electric shaver and comprises plural blade elements arranged in parallel each other.

### BACKGROUND ART

Cutting head of an electric shaver consists of an outer foil blade on which a lot of beard/moustache/whisker introduction apertures are formed and an inner blade or inner blades comprising plural blade elements, and the inner blade is connected with a driving source so as to be reciprocally driven relative to the outer foil blade.

A conventional blade element 30 used for an inner blade, which is described in Japanese Laid-Open Patent Publication No. 6-142347, for example, has cutting edges 32 each having a predetermined angle with an undercut on a side face near to a top end thereof, as shown in FIG. 11A and FIG. 11B. When cutting beards/moustaches/whiskers, a beard, moustache or whisker H which is introduced from the beard/moustache/whisker introduction aperture 11 formed on the outer foil blade 10 is wedged between a cutting edge of the outer foil blade 10 and the cutting edge 32 on the top end of the blade 30, and the beard, moustache or whisker H is cut by moving the blade element 30 parallel to the outer foil blade 10.

As shown in FIG. 11A, it is assumed that the beard, moustache or whisker H is introduced into a center portion of the beard/moustache/whisker introduction aperture 11. The beard, moustache or whisker H is pushed down by the cutting edge 32 of the blade element 30 until it reaches to a front cutting edge of the outer foil blade 10 following to the movement of the blade element 30, as shown in FIG. 11B, and then, under a condition of reaching to the front cutting edge of the outer foil blade 10, the pushed down beard, moustache or whisker H is wedged between and cut by the cutting edge of the outer foil blade 10 and the cutting edge 32 of the blade element 30. Therefore, as shown in FIG. 11C, a front end portion of the beard, moustache or whisker H which is cut in the condition of pushed down slants, and consequently, there is a problem that the beard, moustache or whisker H after cutting cannot be finished short.

In order to solve the above mentioned problem, WO2003/016000 discloses an inner blade which can cut off a beard, moustache or whisker H by only a blade element 30 of the inner blade without pushing down the beard, moustache or whisker H when cutting the beard, moustache or whisker H introduced into a center portion of a beard/moustache/whisker introduction aperture 11.

As shown in FIG. 12A and FIG. 12B, the inner blade shown in WO2003/016000 has a pair of cutting edges 32 provided on both sides of a top end of the blade element 30. This cutting edge 32 is established with a top face of the blade element 30 and a cutting face slanted for the top face. A cusp of the cutting edge 32 is rounded to have a radius of curvature R (μm), and, as an angle of the cutting face for the top face is designated by a symbol α (degree), the radius of curvature R of the cusp of the cutting edge 32 is selected to satisfy a relation that R<−0.067·α+4.7s (μm).

As shown in FIG. 12A, although a beard, moustache or whisker H, which is introduce into a center portion of a beard/moustache/whisker introduction aperture 11, starts to move following to movement of the blade element 30 of an inner blade, it is started to be cut off at a position near to a root thereof by the blade element 30 before it reaches to the cutting edge of the outer foil blade 10. However, the beard, moustache or whisker H which is elastically held on flesh S is pushed down by the cutting edge 32 of the blade element 30, when proceeding the cut off by only the blade element 30, and it is cut aslant a little, as shown in FIG. 12B. Consequently, although the beards, moustaches or whisker can be cut shorter than those in the conventional case shown in Japanese Laid-Open Patent Publication No. 6-142347, a cut face of the beard, moustache or whisker H slants as shown in FIG. 12C. In FIG. 12C, a height of the slanted portion designated by a symbol “h” is equivalent to a quantity that the beard, moustache or whisker H grows in several hours. In order to cut off the cut face of the beard, moustache or whisker H substantially perpendicular to protruding direction of the beard, moustache or whisker H in the root portion of the beard, moustache or whisker H, it is necessary to repeat the cutting by the blade element 30 several times.

### DISCLOSURE OF INVENTION

The present invention is conceived to solve the above mentioned conventional problems, and it is purposed to provide an inner blade for electric shaver which can cut off the beard, moustache or whisker substantially perpendicular to the protruding direction thereof in a root portion of the beard, moustache or whisker.

An inner blade for electric shaver in accordance with an aspect of the present invention comprises plural blade elements which are supported on a base, and reciprocally driven parallel to an outer foil blade having beard/moustache/whisker introduction apertures so as to cut beards, moustaches or whiskers between it and the outer foil blade, wherein the plural blade elements are arranged in parallel each other; a pair of cutting edges is provided symmetrically on both sides of a top portion of each blade element; each cutting edge is established with a top face of the blade element and a cutting face slanted for the top face; a cusp of the cutting edge is rounded to have a radius of curvature R (μm); and as an angle of the cutting face for the top face is designated by a symbol α (degree), the radius of curvature R of the cusp of the cutting edge is selected to satisfy a relation that R≦−0.02·α+1.1 (μm).

According to such a configuration, a beard, moustache or whisker, which is introduced into a center portion of the beard/moustache/whisker introduction aperture of the outer foil blade when cutting the beards, moustaches or whiskers, starts to move following to motion of the blade element of the inner blade, and it is started to be cut at a portion near to root thereof by the blade element of the inner blade before reaching to a front cutting edge of the outer foil blade. Since the radius of curvature R of the cusp of the cutting edge is selected to be smaller than the conventional one shown in the above WO2003/016000, cutting of the beard, moustache or whisker can be continued without push down of the beard, moustache or whisker. Consequently, cut face of the beard, moustache or whisker can be cut substantially perpendicular to protruding direction of the beard, moustache or whisker in the root portion of the beard, moustache or whisker, so that it is possible to cut the beards, moustaches or whiskers shorter without repeating cutting in several times like the conventional case.

### BRIEF DESCRIPTION OF DRAWINGS

FIG. 1 is a drawing showing a schematic configuration of an electric shaver which uses an inner blade for electric shaver in accordance with the present invention.

FIG. 2 is a side view showing a configuration of an inner blade for electric shaver in accordance with an embodiment of the present invention.

FIG. 3 is a sectional view showing a shape of a blade element which constitutes the above inner blade.

FIG. 4A, FIG. 4B and FIG. 4C are explanation drawings showing a method to obtain a radius of curvature of a cusp of a cutting edge of the blade element each having different shape.

FIG. 5 is a graph showing a relation between an angle of a cutting edge and a radius of curvature R of the cusp of the cutting edge for satisfying a condition that cutting resistance of beard, moustache or whisker is equal to or smaller than 0.2 (N).

FIG. 6 is a graph showing relations between the cutting resistances of beard, moustache or whisker and the radius of curvature of the cusp of the cutting edge when varying the angle of a cutting edge α.

FIG. 7 is a graph showing a relation between the cutting resistance of beard, moustache or whisker and an angle θ of cut face of the beard, moustache or whisker.

FIG. 8 is an explanation drawing showing a definition of the angle θ of cut face of the beard, moustache or whisker.

FIG. 9A and FIG. 9B are explanation drawings respectively showing cutting process of beard, moustache or whisker by the inner blade.

FIG. 10 is a sectional view showing an example that a hardening layer is provided on the blade element.

FIG. 11A, FIG. 11B and FIG. 11C are explanation drawings respectively showing a problem when cutting beard, moustache or whisker by a cutting edge of an outer foil blade and a cutting edge of a blade element in a conventional case.

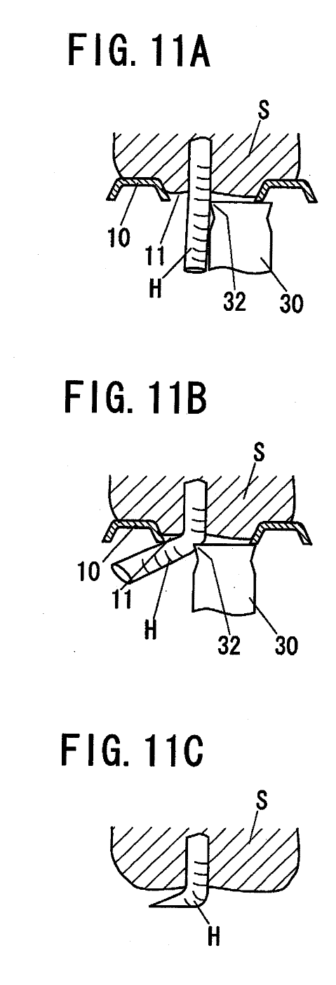

FIG. 12A, FIG. 12B and FIG. 12C are explanation drawings respectively showing a problem when cutting beard, moustache or whisker by only an inner blade in another conventional case.

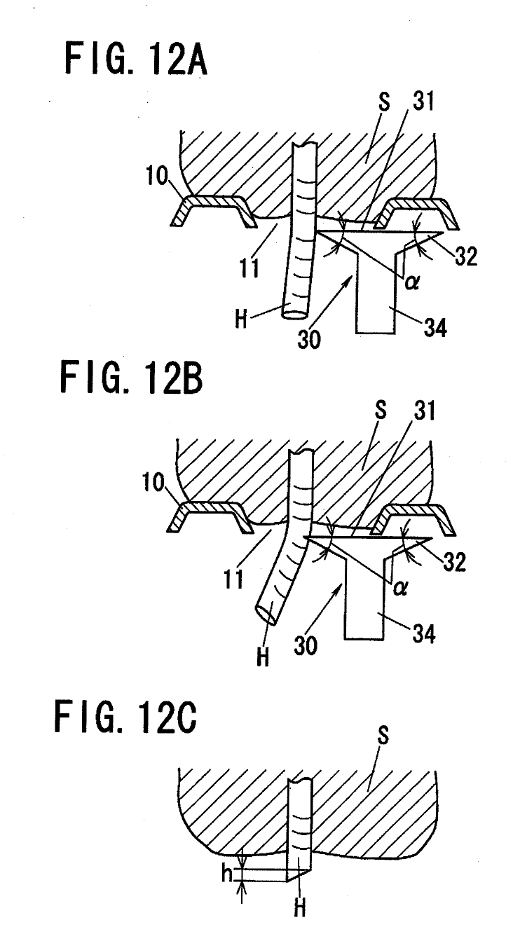

### BEST MODE FOR CARRYING OUT THE INVENTION

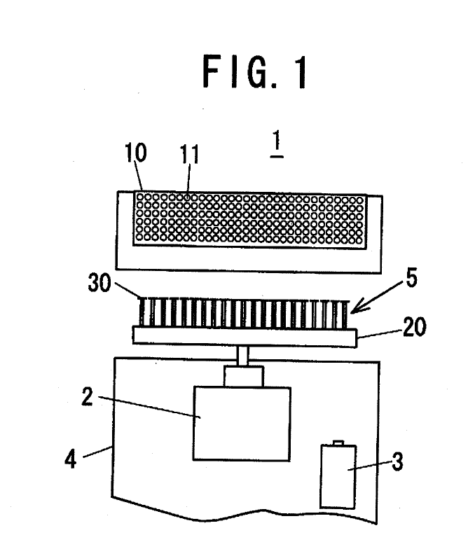

An inner blade for electric shaver in accordance with an embodiment of the present invention is described with reference to drawings. As shown in FIG. 1, an inner blade 5 for electric shaver in accordance with the present invention is applied to a reciprocation driving type electric shaver 1, and it comprises plural pieces of blade elements 30 which are arranged in parallel with each other on a base 20 made of a synthetic resin. The reciprocation driving type electric shaver 1 has a driving mechanism 2 which is configured with a motor contained in a housing 4 and so on, and a rechargeable battery 3, for example. The base 20 of the inner blade 5 is coupled with the driving mechanism 2, and thereby, the inner blade 5 is held in a condition to protrude outward from a top end of the housing 4. An outer foil blade 10 has a lot of beard/moustache/whisker introduction apertures 11 formed approximately uniformly, and the outer foil blade 10 is installed on the top end of the housing 4. The inner blade 5 is reciprocally driven parallel to the outer foil blade 10 by the driving mechanism 2, so that beards, moustaches or whiskers arrested in the beard/moustache/whisker introduction apertures 11 are cut by the blade elements 30. In addition, it is not illustrated in particular, but the housing 4 is formed in a shape which is easily held by a hand of a user.

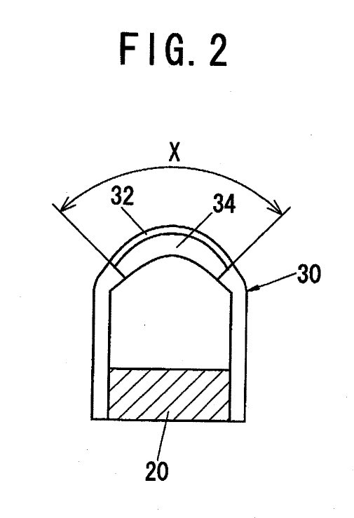

As shown in FIG. 2, each blade element 30 is formed to curve as a reverse U-shape, and both ends thereof are fixed on the base 20. In a center arc region of the blade element 30, cutting edges 32 are formed in a predetermined angular range X (for example, about 100 degrees), and this arc region slides along a lower face of the outer foil blade 10 which is curved in similar shape.

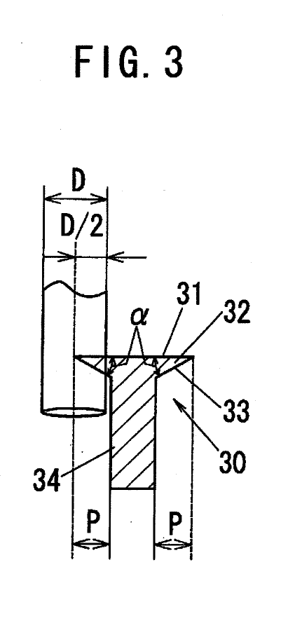

As shown in FIG. 3, a rib 34 is formed at the center of a lower face side of the blade element 30 to protrude downward, and the cutting edges 32 protrude laterally from the top end of the rib 34. Each cutting edge 32 is formed (or established) between a top face 31 of the blade element 30 and a cutting face 33 which slants for the top face 31, and a cusp of the cutting edge 32 is rounded to have a radius of curvature R (unit: μm). When an angle of the cutting face 33 for the top face 31 is designated by a symbol α (unit: degree), the radius of curvature R of the cusp of the cutting edge 32 is selected to satisfy a relation R≦−0.02·α+1.1 (μm).

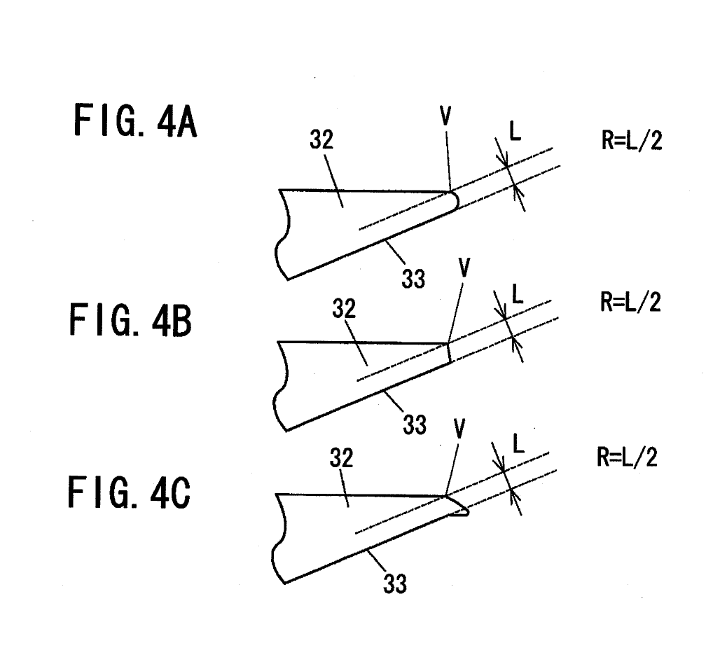

By the way, the cutting edge 32 tends to have a shape shown in FIG. 4A to FIG. 4C corresponding to the finishing degree. Therefore, the radius of curvature R of the cutting edge 32 defined in the present invention is estimated by approximation from an effective minimum thickness L of a cutting edge (R=L/2). In other words, the radius of curvature R is defined as R=L/2 for the shapes shown in FIG. 4A to FIG. 4C, because a distance L between an extension of the cutting face 33 and a line which passes through an inflection point V of the top face of the blade element 30 in the cutting edge 32 side and is parallel to the cutting face 33 can be regarded as the effective minimum length.

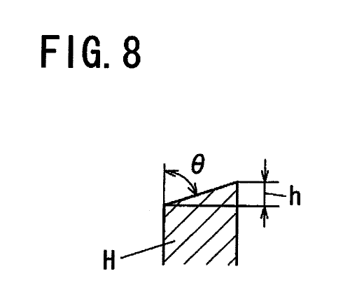

Subsequently, as shown in FIG. 8, an angle established by a cut face of the beard, moustache or whisker H with respect to protruding direction thereof from flesh S was defined as an angle θ of cut face of the beard, moustache or whisker (unit: degree). Then, a relation between the angle α (unit: degree) of the cutting edge and the radius of curvature R of the cusp of the cutting edge 32 was obtained to satisfy a condition that the angle θ of cut face of the beard, moustache or whisker became substantially perpendicular to the protrusion of the beard, moustache or whisker H, in other words, the angle θ of cut face of the beard, moustache or whisker became equal to or larger than 85 degrees.

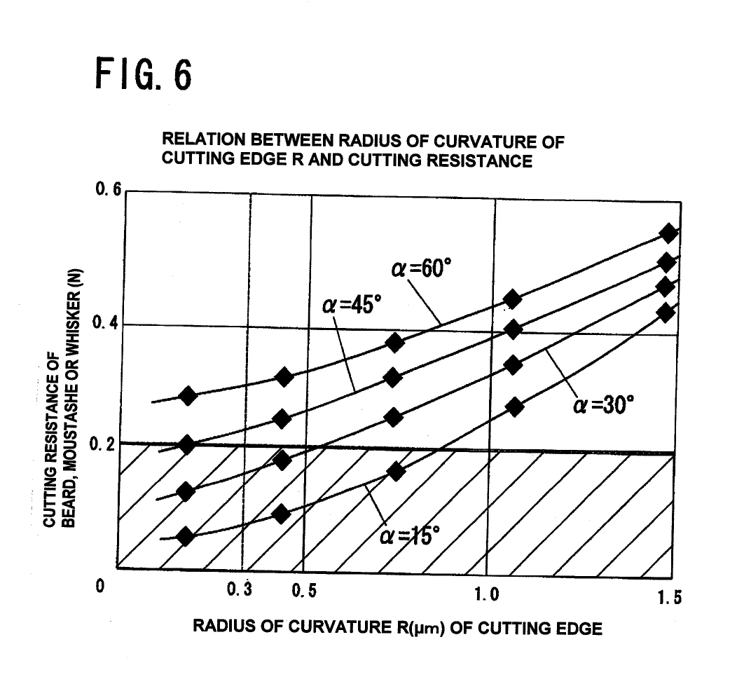

First, the angle α of the cutting edge was set in various angles, and relations between cutting resistances of beard, moustache or whisker (unit: N) and the radius of curvature R (unit: μm) of the cusp of the cutting edge were obtained in experiments. In the experiments, relations between the cutting resistances of beard, moustache or whisker and the radius of curvature R of the cusp of the cutting edge were obtained in cases that the angle α of the cutting edge was equal to 15, 30, 45 and 60 degrees. The experimental results are shown in FIG. 6. As can be seen from FIG. 6, when the angle α of the cutting edge is constant, the smaller the radius of curvature R of the cusp of the cutting edge is, the smaller the cutting resistance of beard, moustache or whisker becomes. In addition, when the radius of curvature R of the cusp of the cutting edge is constant, the smaller the angle α of the cutting edge is, the smaller the cutting resistance of beard, moustache or whisker becomes.

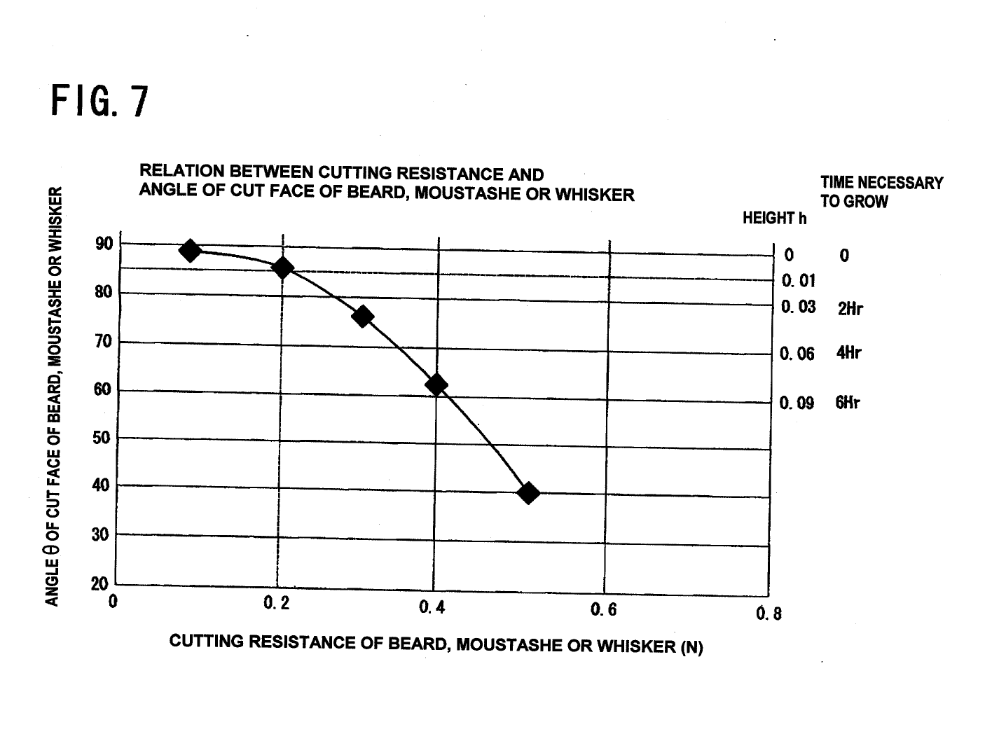

Subsequently, a relation between the cutting resistance of beard, moustache or whisker and the angle θ of cut face of the beard, moustache or whisker was obtained when two parameters of the angle θ of cut face of the beard, moustache or whisker and the radius of curvature R of the cusp of the cutting edge were substituted for the cutting resistance of beard, moustache or whisker. The results are shown in FIG. 7. In general, since a cutting velocity of the inner blade of electric shaver is equal to or faster than 0.5 m/s (that is, the slowest cutting velocity of the inner blade among the general electric shavers is about 0.5 m/s), the cutting of beards, moustaches or whiskers was performed by setting the cutting velocity of the inner blade to be 0.5 m/s.

Heights “h” (unit: mm) of inclination portions of the beard, moustache or whisker H due to cutting were obtained in experiments in cases that the angle θ of cut face of the beard, moustache or whisker was 90, 85, 80, 70 and 60 degrees. The experimental results are shown in FIG. 7. In case of θ=90 degrees, the height h=0 (mm). In case of θ=85 degrees, the height h=0.001 (mm). In case of θ=80 degrees, the height h=0.03 (mm). In case of θ=70 degrees, the height h=0.06 (mm). In case of θ=60 degrees, the height h=0.09 (mm). By the way, as for a time necessary to grow the beards, moustaches or whiskers, it needs two hours to grow 0.03 mm, four hours to grow 0.06 mm and six hours to grow 0.09 mm, in general. Therefore, in the case of θ=80 degrees, a quantity of the grow of beard, moustache or whisker in two hours is remained. In the case of θ=70 degrees, a quantity of the grow of beard, moustache or whisker in four hours is remained. In the case of θ=60 degrees, a quantity of the grow of beard, moustache or whisker in six hours is remained. Therefore, if the angle θ is less than 85 degrees, a quantity of the beard, moustache or whisker which is necessary more than one hour to grow will be remained, and thus, it is found unfavorable.

As obvious from FIG. 7, it is found that the condition that the angle θ of cut face of the beard, moustache or whisker becomes equal to or larger than 85 degrees is the cutting resistance of beard, moustache or whisker equal to or smaller than 0.2 (N). In other words, when the cutting resistance of beard, moustache or whisker is equal to or smaller than 0.2 (N), the angle θ of cut face of the beard, moustache or whisker becomes equal to or larger than 85 degrees, and thus, the beard, moustache or whisker H can be cut substantially perpendicular to protruding direction thereof.

This fact means that the inner blade comprising the blade elements 30, which satisfy the conditions of the angle α of the cutting edge and the radius of curvature R of the cusp of the cutting edge 32 included in an area where the cutting resistance of beard, moustache or whisker is equal to or smaller than 0.2 (N) (in a hatched area in FIG. 6), enables to cut the beard, moustache or whisker H so that the angle θ of cut face of the beard, moustache or whisker becomes equal to or larger than 85 degrees.

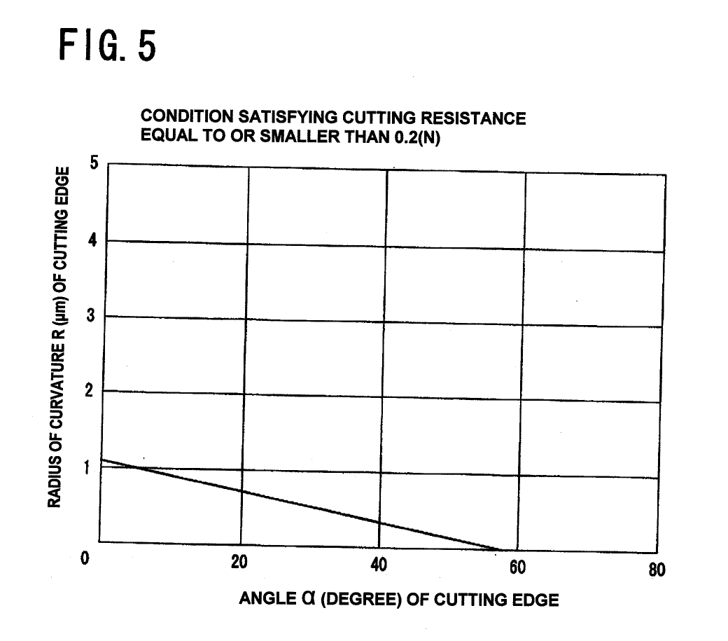

Therefore, in the present invention, it was noticed the fact that the angle θ of cut face of the beard, moustache or whisker became equal to or larger than 85 degrees when the cutting resistance of beard, moustache or whisker was equal to or smaller than 0.2 (N), and relations between the angle α (unit: degree) of the cutting edge and the radius of curvature R (unit: μm) of the cusp of the cutting edge 32 satisfying the condition that the cutting resistance of beard, moustache or whisker is equal to or smaller than 0.2 (N) were obtained. When such conditions are expressed in arithmetic formula, it can be shown with R≦−0.02·α+1.1 (μm). When it is expressed in chart, it is as shown in FIG. 5.

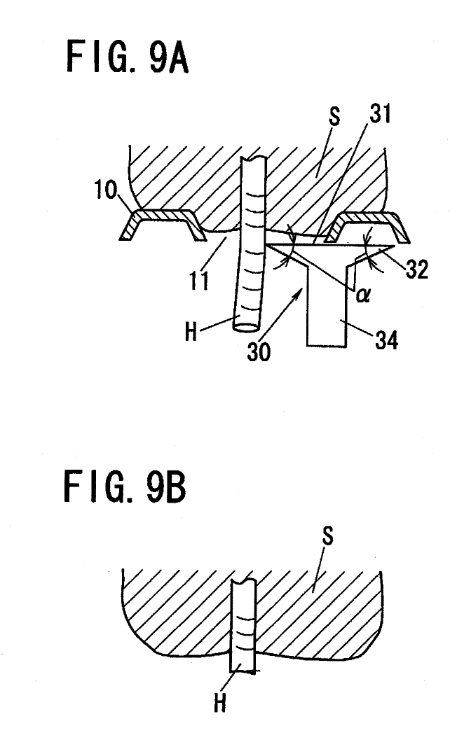

In other words, when the inner blade comprises the blade elements 30 which satisfies the conditions of the angle α of the cutting edge and the radius of curvature R of the cusp of the cutting edge 32 included in an area below a line expressed by a formula R≦−0.02·α+1.1 (μm) in FIG. 5, even though the beard, moustache or whisker H introduced into the center portion of the beard/moustache/whisker introduction aperture 11 in cutting process of the beards, moustaches or whiskers H, it starts to be moved following to the motion of the blade element 30, but it is started to be cut off at a position near to the root thereof by the blade element 30 before reaching to the front edge of the outer foil blade 10, and the cutting is continued without inclination of the beard, moustache or whisker H, as shown in FIG. 9A and FIG. 9B. Consequently, it is possible to cut the beard, moustache or whisker in the root portion thereof by only the blade element 30 of the inner blade so that the cut face of the beard, moustache or whisker H becomes substantially perpendicular to the protrusion of the beard, moustache or whisker H from flesh S (in other words, the angle of the cut face becomes equal to or larger than 85 degrees), and thus, it is possible to cut the beards, moustaches or whiskers shorter without repeating the cutting several tiles like the conventional case.

As mentioned above, since the cutting resistance of beard, moustache or whisker becomes smaller as increasing the cutting velocity of the inner blade, when the cutting velocity of the inner blade is equal to or faster than 0.5 m/s, the cutting resistance of beard, moustache or whisker tends to be reduced, and thus, it is obvious to satisfy the above mentioned relationship. Consequently, in all electric shavers having general cutting velocity, it is possible to cut the beard, moustache or whisker so that the cut face thereof becomes substantially perpendicular to the protruding direction (the angle of the cut face becomes equal to or larger than 85 degrees) by only the inner blade.

In addition, as obvious from FIG. 6, when the angle α of the cutting edge is 60 degrees, since the cutting resistance of beard, moustache or whisker cannot become equal to or smaller than 0.2 (N), it is preferable that the angle α of the cutting edge should be less than 60 degrees, and more preferably, be equal to or smaller than 45 degrees (α≦45 degrees).

In addition, although the lower limit of the cutting resistance of beard, moustache or whisker (N) is not limited in particular, it is preferable to be equal to or larger than 0.02 (N) in consideration with production restriction of the blade elements 30.

By the way, as shown in FIG. 3, protruding quantity P of the cutting edges 32 on both sides of the top face of the blade element 30 from the rib 34 is selected to be equal to or larger than 0.05 mm. This is based on the following reasons. A diameter D of general beard, moustache or whisker H is about 0.1 mm. When cutting the beard, moustache or whisker H by the cutting edge 32 of the blade element 30 as shown in FIG. 3, in order not to contact the rib 34 with the beard, moustache or whisker H until the beard, moustache or whisker H is cut more than half in radial direction, in other words, in order not to push down the beard, moustache or whisker H by contacting the rib 34 with the beard, moustache or whisker H before cutting more than half, the protruding quantity P of the cutting edges 32 on both sides of the top face of the blade element 30 from the rib 34 is necessary to be equal to or more than 0.05 mm. By satisfying such a condition, the rib 34 contacts the beard, moustache or whisker H after cutting more than half of the beard, moustache or whisker H in the radial direction, so that it is possible to cut the beard, moustache or whisker H without pushing down.

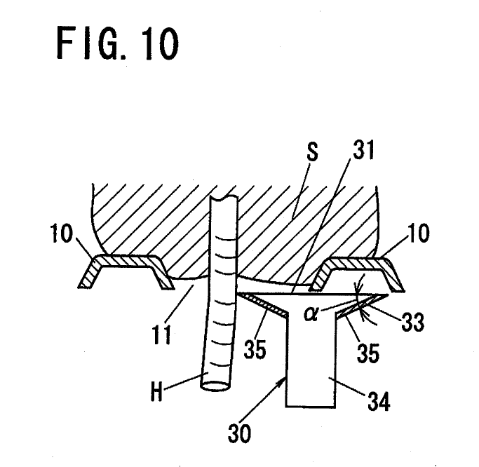

In addition, as shown in FIG. 10, a hardening layer 35 is formed on each cutting face 33 which establishes the cutting edge 32. Thereby, wear of the cutting edge 32 can be prevented, and sharpness can be maintained for a long term. The hardening layer 35 can be formed by integrally superimposing a clad material such as Ti or Al on a base material of the blade element 30. Alternatively, the hardening layer 35 can be formed by processing heat treatment such as laser quenching or impact quenching on a surface of a base material of the blade element 30. Furthermore, it is possible to form the hardening layer by coating TiN, TiC, CrN or hard carbon film on a surface of a base material of the blade element 30. In addition, the hardening layer 35 may be formed on the top face 31 of the blade element 30 further to the cutting face 33.

Besides, the inner blade in accordance with the present invention can be applied to an inner blade of other types of electric shavers other than the reciprocation type electric shaver, and by providing the above mentioned unique cutting edges are formed on a blade element, cutting effect of beards and moustaches can be increased.

This application is based on Japanese patent application 2006-199953, the contents of which are hereby incorporated by references of the specification and drawings.

Although the present invention has been fully described by way of example with reference to the accompanying drawings, it is to be understood that various changes and modifications will be apparent to those skilled in the art. Therefore, unless otherwise such changes and modifications depart from the scope of the present invention, they should be construed as being included therein.

1. An inner blade for electric shaver comprising plural blade elements which are supported on a base, and reciprocally driven parallel to an outer foil blade having beard/moustache/whisker introduction apertures so as to cut beards, moustaches or whiskers by the inner blade and the outer foil blade, wherein
the plural blade elements are arranged in parallel each other;
a pair of cutting edges is provided symmetrically on both sides of a top portion of each blade element;
each cutting edge is established with a top face of the blade element and a cutting face slanted for the top face;
a cusp of the cutting edge is rounded to have a radius of curvature R (μm); and
as an angle of the cutting face for the top face is designated by a symbol α (degree), the radius of curvature R of the cusp of the cutting edge is selected to satisfy a relation that
R≦−0.02·α+1.1 (μm).

2. The inner blade for electric shaver in accordance with claim 1, wherein
a rib is formed to protrude downward at a center on a lower face side the blade element and the cutting edges are protruded outward from a top end of the rib; and
a protruding quantity of the cutting edge on each side of the top face of the blade element from the rib is equal to or larger than 0.05 mm.

3. The inner blade for electric shaver in accordance with claim 1, wherein
a hardening layer is formed on each cutting face which establishes the cutting edge.

4. The inner blade for electric shaver in accordance with claim 3, wherein
a hardening layer is further formed on the top face of the blade element which established the cutting edge.
